(19) United States
(12) Patent Application Publication
(10) Pub. No.: US 2008/0100604 A1
(43) Pub. Date: May 1, 2008

(54) Driving circuit for liquid crystal display and burning system for burning same

(75) Inventor: Huai Du, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZEN) CO., LTD.; INNOLUX DISPLAY CORP.

(21) Appl. No.: 11/978,277

(22) Filed: Oct. 29, 2007

(30) Foreign Application Priority Data
Oct. 27, 2006 (TW) 95139819

(51) Int. Cl. G09G 5/00; G09G 3/36

(52) U.S. Cl. 345/205; 345/90

(57) ABSTRACT

An exemplary driving circuit (20) for an LCD includes a driving chip (22) configured to drive the LCD, a flexible printed circuit (23) electrically connected to the driving chip and an identification register (24). The identification register is located on the flexible printed circuit and stores identification information distinguishing the physical characteristics of the driving chip. The driving chip directly reads the identification information from the identification register.

### FIELD OF THE INVENTION

The present invention relates to a driving circuit of a liquid crystal display (LCD), and to a burning system for writing identification information to a driving chip of a driving circuit of an LCD.

### GENERAL BACKGROUND

Every type of LCD needs it own specific display software to be adapted to specific requirements and parameters such as specific memory organization, control register setting, contrast tables, initial frame frequency setting, and common electrode driving signals, etc. of specific driving chips. This means versions of the display software must be adapted to the types of the driving chips. Commonly, LCD manufacturers write the version, the type, and the manufacture information to the specific driving chips using a burning process.

Referring to FIG. 2, a typical driving circuit 10 for an LCD in a burning process is shown. The driving circuit 10 is configured to provide various operating voltages and displaying data signals to a liquid crystal panel (not shown). The driving circuit 10 includes a driving chip 12 and a flexible printed circuit (FPC) 13. The driving chip 12 is mounted on one of two substrates of the liquid crystal panel by chip on glass (COG) technology. The FPC 13 is electrically connected to the driving chip 12 via wiring lines arranged on the substrate.

An identification register 122 located within the driving chip 12 is configured to store all identification information for distinguishing physical characteristics of the driving chip 12. The FPC 13 includes a first connector 131 and a second connector 132. Both the first connector 131 and the second connector 132 are configured for providing communication channels between the identification register 122 and interfaces of an external circuit. The external circuit can be a burning circuit or another kind of circuit such as a testing circuit.

A burning circuit (not labeled) is generally used when the identification information is written to the identification register 122. The burning circuit includes a power source 15 and a microprocessor unit (MPU) 16. The power source 15 provides a +15V burning voltage and a 150 mA burning current to the driving chip 12 via the first connector 131. The MPU 16 controls the power source 15 and stores a burning program required in a burning process and data edited according to the physical characteristics of the driving chip 12.

The MPU 16 includes an input/output (I/O) interface 161 and a control interface 162. The I/O interface 161 is correspondingly connected to the second connector 132. The control interface 162 outputs a control signal to control the power source 15. If the control signal is low, the power source 15 outputs the +15V burning voltage and the 150 mA burning current to the driving chip 12 via the first connector 131. Simultaneously the MPU 16 processes the data in order to obtain the corresponding identification information and runs the burning program, thereby writing the identification information to the identification register 122 via the I/O interfaces 161 and the second connector 132 in sequence. If the control signal is high, the power source 15 is switched off and writing of the identification information to the identification register 122 ceases.

However, because the power source 15 is subject interference, the burning voltage and the burning current maybe exceed maximum operating voltages and therefore protecting devices for other circuits of the driving chip 12 may be fused, thereby damaging the other circuits. Furthermore, because of instabilities of the burning voltage or the burning current, the identification information written into the driving chip 12 may contain errors. If the driving chip 12 is damaged or wrongly burnt, it needs be replaced with a new driving chip 12. In summary, the reliability of the burning process is poor; and the cost of discarding faulty driving chips 12 inflates to the cost of manufacturing the LCD.

What is needed, therefore, is a driving circuit of an LCD that can overcome the above-described deficiencies. What is also needed is a burning system to write identification information to the driving circuit. What is further needed is a liquid crystal display employing the driving circuit.

### SUMMARY

In one preferred embodiment, a driving circuit for an LCD includes a driving chip configured to drive the LCD, a flexible printed circuit electrically connected to the driving chip and an identification register. The identification register is located on the flexible printed circuit and stores identification information distinguishing the physical characteristics of the driving chip. The driving chip directly reads the identification information from the identification register.

Other novel features and advantages will become more apparent from the following detailed description when taken in conjunction with the accompanying drawings.

### BRIEF DESCRIPTION OF THE DRAWINGS

FIG. 1 is a block diagram of a driving circuit of an LCD in a burning process according to an exemplary embodiment of the present invention.

FIG. 2 is a block diagram of a conventional driving circuit of an LCD in a burning process.

### DETAILED DESCRIPTION OF PREFERRED EMBODIMENTS

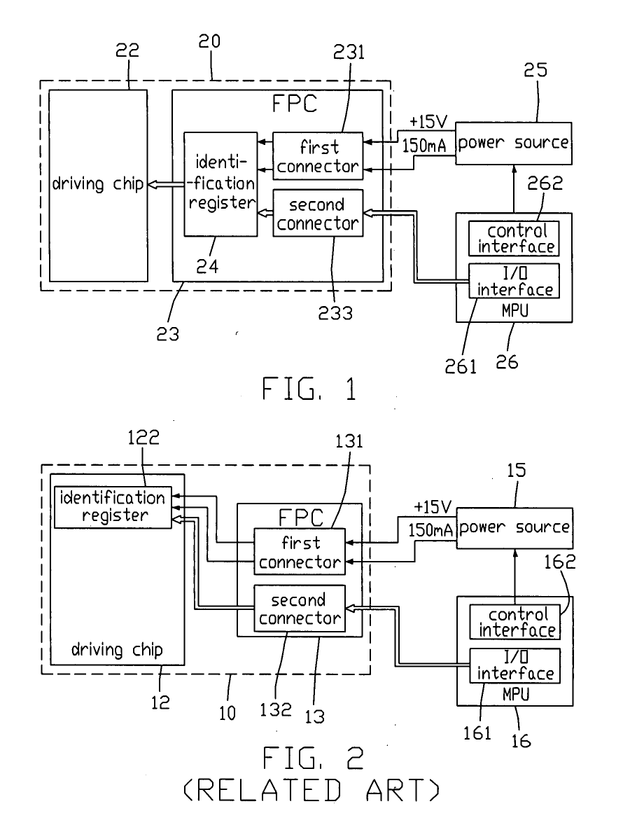

Referring to FIG. 1, a driving circuit 20 of an LCD according to an exemplary embodiment of the present invention in a burning process is shown. The LCD further includes a liquid crystal panel (not shown) and a backlight module (not shown). The backlight module provides uniform light beams to the liquid crystal panel. The liquid crystal panel includes a first substrate, a second substrate, and a liquid crystal layer sandwiched between the two substrates. The driving circuit 20 is configured to drive the liquid crystal panel.

The driving circuit 20 includes a driving chip 22, an FPC 23, and an identification register 24. The driving chip 22 is mounted on the fringe of the second substrate by COG technology. The FPC 23 is connected to the driving chip 22 thereby providing a communicating channel between a first external circuit and the driving chip 22. The first external circuit can be a power circuit board or a control circuit board. The power circuit board may provide operation voltages to the liquid crystal panel and the driving chip 22. The control circuit board may provide data signals to the liquid crystal panel via the driving chip 22 and the FPC 23. The identification register 24 is mounted on the FPC 23 by chip on film (COF) technology.

The FPC 23 includes a first connector 231 and a second connector 233. Both the first connector 231 and the second connector 233 are configured to provide communication channels between the identification register 24 and interfaces of an external circuit, for example a burning circuit or a testing circuit.

The identification register 24 records the identification information of the driving chip 22. The identification information contains all information which is used to distinguish the physical characteristics of the driving chip 22. Such information commonly includes the manufacturer, the type and the version of the driving chip 22. The identification register 24 can be a one-time programmable (OTP) register or a multiple-time programmable (MTP) register. The driving chip 22 needs to read the identification information from the identification register 24 before it is used. In order to write the identification information to the identification register 24, a burning circuit (not labeled) is needed to generate and control the identification information written to the identification register 24.

The burning circuit includes a power source 25 and a microprocessor unit (MPU) 26. The power source 25 provides a +15V burning voltage and a 150 mA burning current to the identification register 24 via the first connector 231. The power source 25 can be a constant-current source or a constant voltage source. The MPU 26 stores a burning program required in a burning process, for example an OTP burning program or an MTP burning program, and data edited according to the physical characteristics of the driving chip 22.

The MPU 26 includes an input/output (I/O) interface 261 and a control interface 262. The I/O interface 261 is correspondingly connected to the second connector 233. The control interface 262 controls switching off and switching on of the power source 25. The MPU 26 can be a single chip microcomputer (SCM) system.

In the burning process, the control interface 262 outputs a low-level voltage to the power source 25. The power source 25 begins working and outputs the +15V burning voltage and the 150 mA burning current to the identification register 24 via the first connector 231. Simultaneously, the MPU 26 processes the data in order to obtain the corresponding identification information and runs the burning program. Therefore, the corresponding identification information is written to the identification register 24 via the I/O interfaces 261 and the second connector 233 in the coordination with the +15V burning voltage and the 150 mA burning current. After the burning process is complete, the MPU 26 outputs a high-level voltage to the power source 25 thereby the power source 25 is switched off. The driving chip 22 directly reads the identification information from the identification register 24 via corresponding pads of the FPC 23 and the driving chip 22.

Because the +15V burning voltage and the 150 mA burning current directly input to the identification register 24 mounted on the FPC 23 and cannot input to the driving chip 22, the driving chip 22 can avoid being damaged even if the burning voltage and the burning current exceed maximum operating values. Furthermore, if the FPC 23 is damaged or the identification register 24 is wrongly burnt, only the FPC 23 needs to be replaced. There is no need to replace the driving chip 22. In addition, removing the FPC 23 from the second substrate is easier than removing the driving chip 22. In summary, the reliability of the burning process is improved, and the cost of repairing the driving circuit 20 reduced.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A driving circuit of a liquid crystal display (LCD), the driving circuit comprising:
a driving chip configured to drive the LCD;
a flexible printed circuit (FPC) electrically connected to the driving chip; and
an identification register located on the flexible printed circuit and storing identification information, the identification information distinguishing physical characteristics of the driving chip;
wherein the driving chip directly reads the identification information from the identification register.

2. The driving circuit as claimed in claim 1, wherein the identification information comprises data of the manufacturer, the type, and the version of the driving chip.

3. The driving circuit as claimed in claim 1, wherein the identification register is a one-time programmable register.

4. The driving circuit as claimed in claim 1, wherein the identification register is a multiple-time programmable register.

5. The driving circuit as claimed in claim 1, wherein the FPC comprises at least two connectors configured for connecting with interfaces of external circuits and thereby functioning as communication channels between the identification register and the external circuits.

6. A burning system for writing identification information to a driving chip of a liquid crystal display (LCD), the burning system comprising:
a flexible printed circuit electrically connected to the driving chip;
an identification register located on the flexible printed circuit and storing the identification information, the identification information distinguishing physical characteristics of the driving chip; and
a burning circuit configured to write the identification information to the identification register;
wherein the driving chip is able to directly read the identification information from the identification register.

7. The burning system as claimed in claim 6, wherein the identification information comprises data of the manufacturer, the type and the version of the driving chip.

8. The burning system as claimed in claim 6, wherein the identification register is a one-time programmable register.

9. The burning system as claimed in claim 6, wherein the identification register is a multiple-time programmable register.

10. The burning system as claimed in claim 6, wherein the burning circuit comprises a power source providing a burning voltage and a burning current to the identification register.

11. The burning system as claimed in claim 10, wherein the power source is a constant-current source.

12. The burning system as claimed in claim 10, wherein the power source is a constant voltage source.

13. The burning system as claimed in claim 10, wherein the burning circuit further comprises a microprocessor unit, and the microprocessor unit stores a burning program and data edited according to the identification information.

14. The burning system as claimed in claim 13, wherein the identification information is written to the identification register in corporation with the burning voltage and the burning current.

15. The burning system as claimed in claim 13, wherein the microprocessor unit is a single chip microcomputer.

16. The burning circuit as claimed in claim 13, wherein the microprocessor unit comprises an input/output interface configured for transmitting the identification information from the microprocessor unit to the identification register.

17. The burning system as claimed in claim 13, wherein the microprocessor unit further comprises a control interface outputting a control signal to control the power source.

18. A liquid crystal display comprising:
a first substrate;
a second substrate opposite to the first substrate;
a liquid crystal layer sandwiched between the first substrate and the second substrate;
a driving chip mounted on the second substrate;
a flexible printed circuit (FPC) electrically connected to the driving chip; and
an identification register located on the flexible printed circuit and storing identification information, the identification information distinguishing physical characteristics of the driving chip;
wherein the driving chip directly reads the identification information from the identification register.

19. The liquid crystal display as claimed in claim 18, wherein the identification information comprises data of the manufacturer, the type, and the version of the driving chip.

20. The liquid crystal display as claimed in claim 18, wherein the identification register is selected from the group consisting of a one-time programmable register or a multiple-time programmable register.
